(19) United States
(12) Patent Application Publication
(10) Pub. No.: US 2026/0249475 A1
(43) Pub. Date: Aug. 27, 2026

(54) AUTONOMOUS LOADING AND UNLOADING ROBOT AND CONTROL METHOD THEREFOR

(71) Applicant: SENAD DIGITAL TECHNOLOGY (JIAXING) CO., LTD., JIAXING (CN)

(72) Inventors: HUA LI, JIAXING (CN); YISHAN WANG, JIAXING (CN); KAI GUO, JIAXING (CN); XIANCHUN SHAN, JIAXING (CN)

(73) Assignee: SENAD DIGITAL TECHNOLOGY (JIAXING) CO., LTD., JIAXING (CN)

(21) Appl. No.: 19/409,858

(22) Filed: Dec. 5, 2025

(30) Foreign Application Priority Data
Feb. 25, 2025 (CN) 202510205921.X

(51) Int. Cl. B25J 9/16; B25J 5/00; B25J 13/08; B25J 15/06; B25J 19/02

(52) U.S. Cl. CPC B25J 9/1697; B25J 5/005; B25J 9/1669; B25J 13/088; B25J 15/0683; B25J 19/023

(57) ABSTRACT

Provided are an autonomous loading and unloading robot and a control method therefor. The autonomous loading and unloading robot includes: a movable chassis, a robotic arm moving along with the chassis, a sucking disc detachably connected to an end of the robotic arm and configured to attach to a cargo box by suction, a front camera module configured to acquire position and size parameters of a cargo box to be moved, and a conveying module detachably connected to the chassis and configured to receive the cargo box moved by the sucking disc and convey the cargo box, where a lifting module capable of adjusting a height of the robotic arm is detachably connected to the chassis; a height sensor is detachably connected to the robotic arm; and the height sensor, the front camera module, and the lifting module are electrically connected to a controller.

### CROSS-REFERENCE TO RELATED APPLICATIONS

This application claims priority of Chinese Patent Application No. 202510205921.X, filed on February 25, 2025, the contents of which are hereby incorporated by reference.

### TECHNICAL FIELD

This application relates to the field of automated loading and unloading robot technologies, and in particular, to an autonomous loading and unloading robot and a control method therefor.

### BACKGROUND

During the logistics transportation process, loading and unloading of cargo boxes are required. The cargo boxes are generally cartons of different sizes within corresponding standards. If the loading and unloading of the cargo boxes are performed manually, not only is the efficiency low, but the cargo boxes are also prone to being randomly discarded, resulting in damage to the goods inside. For this reason, some automated loading and unloading robots have been designed and manufactured to be suitable for large-volume cargo box loading and unloading operations.

For example, in a loading and unloading integrated machine and a loading and unloading system with Publication No. CN220244879U, a sucking disc capable of moving a cargo box is provided at an end of a robotic arm, and a corresponding camera system is provided at a front end of a moving platform to enable localization of the position of the cargo box, so that the sucking disc can accurately attach onto the surface of the cargo box by suction, and then the cargo box is moved to a corresponding conveying mechanism for backward conveyance.

With respect to the related art mentioned above, the height that the robotic arm can reach is relatively limited. When facing some stacked cargo boxes with a relatively high height, it is difficult to make the sucking disc attach to the center of the surface of the relatively tall cargo box by suction by relying solely on the robotic arm, such that the sucking disc cannot stably attach to the cargo box by suction, and the relatively high cargo box is prone to falling and being damaged during the movement along with the sucking disc.

### SUMMARY

To reduce the possibility of a relatively tall cargo box falling and being damaged while moving along with a sucking disc, the present application provides an autonomous loading and unloading robot and a control method therefor.

In a first aspect, the autonomous loading and unloading robot provided by the present application adopts the following technical solution:

An autonomous loading and unloading robot includes: a movable chassis, a robotic arm moving along with the chassis, a sucking disc detachably connected to an end of the robotic arm and configured to attach to a cargo box by suction, a front camera module configured to acquire position and size parameters of a cargo box to be moved, and a conveying module detachably connected to the chassis and configured to receive the cargo box moved by the sucking disc and convey the cargo box, where a lifting module capable of adjusting a height of the robotic arm is detachably connected to the chassis; a height sensor is detachably connected to the robotic arm; and the height sensor, the front camera module, and the lifting module are electrically connected to a controller.

By adopting the above technical solution, when the height of a carton is relatively high, the lifting module can drive the robotic arm to move upward, thereby improving the reachability of the robotic arm in terms of height.

Optionally, a rear camera module is detachably connected to the chassis near a rear end of the conveying module and configured to confirm whether a cargo box exists at a designated position at the rear end of the conveying module, and the rear camera module is electrically connected to the controller.

By adopting the above technical solution, when the cargo box moves into the designated area at the rear end of the conveying module, the conveying module will stop conveying, so that an external clamping jaw can accurately clamp and transfer cargo boxes of different sizes and at different positions within a certain area range.

Optionally, a rotating module is detachably connected to a position of the lifting module where height is changeable, a position of the rotating module where it is rotatable is used for detachable connection of the robotic arm; and the front camera module is detachably connected to the robotic arm.

By adopting the above technical solution, the robotic arm and the front camera module can rotate synchronously, thereby improving the reachable range of the robotic arm in a horizontal plane and expanding the field of view coverage of the front camera module.

Optionally, the lifting module is located at a side edge of the conveying module along a conveying direction.

By adopting the above technical solution, the overall space occupation of the present application is reduced, so that the present application can load and unload cargo boxes in smaller spaces such as carriages.

Optionally, a base block is detachably connected to a position of the lifting module where the height is changeable, a slider capable of moving to a position directly above the conveying module is slidably connected to the base block, the robotic arm is capable of moving along with the slider, and a translational power component for driving the slider to move is detachably connected to the base block.

By adopting the above technical solution, the robotic arm can be moved to a position directly above the side of the chassis where the conveying module is provided, thereby further improving the reachability of the robotic arm, so that the reachability of the robotic arm is not easily affected while the space occupation of the present application is reduced.

Optionally, two belt wheels are rotatably connected inside the slider, a synchronous belt is drivingly connected between the two belt wheels, a lower belt block fixedly connected to the synchronous belt is detachably connected to a side of the base block close to the conveying module, and the belt wheels are driven by the translational power component to rotate.

By adopting the above technical solution, the slider can be moved without the need to provide a linear actuator such as an electric cylinder with a large length, so as to reduce the overall space occupation of the present application.

Optionally, the slider includes a middle block slidably connected to the base block and an upper block slidably connected to the middle block, the middle block and the upper block have a same sliding direction, and an upper belt block fixedly connected to the synchronous belt is detachably connected to a side of the upper block away from the conveying module.

By adopting the above technical solution, while the middle block moves, the upper block can also move synchronously relative to the middle block, which improves the movement range of the robotic arm to adapt to conveying modules with a larger width, and also helps to reduce the overall space occupation of the present application.

Optionally, the upper belt block and the lower belt block are each detachably connected with a fastening block that is capable of being in close contact with the synchronous belt and drivingly connected to surfaces of the belt wheels.

By adopting the above technical solution, the external force borne at the connection between the upper belt block and the synchronous belt as well as the connection between the lower belt block and the synchronous belt are not prone to being excessively large, so that the middle block and the upper block can move effectively for a long time.

Optionally, the fastening block is fixedly connected to a block rack capable of meshing with the synchronous belt.

By adopting the above technical solution, even if a problem occurs with the connection between the upper belt block and the synchronous belt as well as the connection between the lower belt block and the synchronous belt, as long as the connection between the fastening block and the upper belt block as well as the connection between the fastening block and the lower belt block are not released, the upper belt block and the lower belt block can still stably move along with the synchronous belt.

In a second aspect, the control method for an autonomous loading and unloading robot provided by the present application adopts the following technical solution:

A control method for an autonomous loading and unloading robot, for controlling the autonomous loading and unloading robot as described above, specifically including the following steps:

Step 1: acquiring position and size parameters of a cargo box by the front camera module, and judging whether a height of the cargo box exceeds a preset height;

Step 2: when the height of the cargo box exceeds the preset height, calculating a difference between the height of the cargo box and the preset height to obtain a lifting height, and lifting the robotic arm by the lifting module with a lifting value being the lifting height;

Step 3: attaching to a center of a surface of the cargo box by suction by the sucking disc, and transferring the cargo box to a position directly above a front end of the conveying module by the robotic arm;

Step 4: lowering the cargo box by the sucking disc, and conveying the cargo box to a rear end of the conveying module by the conveying module;

Step 5: acquiring position and size parameters of the cargo box located at the rear end of the conveying module by the rear camera module; and

Step 6: grasping and transferring the cargo box at the rear end of the conveying module by an external clamping jaw.

By adopting the above technical solution, when the height of the cargo box is relatively high, the height of the robotic arm can be increased, thereby improving the reachability of the robotic arm in terms of height, and it is not easy for the cargo box to fall and be damaged during the loading and unloading process of the cargo box due to an improper attachment position of the cargo box.

In summary, the present application includes at least the following beneficial effects:

when the height of the carton is relatively high, the lifting module can drive the robotic arm to move upward, thereby improving the reachability of the robotic arm in terms of height.

### BRIEF DESCRIPTION OF THE DRAWINGS

FIG. 1 is a schematic diagram of an overall structure of Embodiment I of the present application;

FIG. 2 is a block diagram of a partial control system of Embodiment I of the present application;

FIG. 3 is a schematic diagram of a structure between a base block and a slider of Embodiment II; and

FIG. 4 is a cross-sectional structural schematic diagram of the base block, the slider, and a fastening block corresponding to a lower belt block in Embodiment II.

Explanation of reference numerals: 1 chassis; 2 robotic arm; 3 sucking disc; 4 front camera module; 41 synchronous belt; 42 lower belt block; 43 middle block; 44 upper block; 45 upper belt block; 46 fastening block; 47 block rack; 5 conveying module; 51 lifting module; 52 height sensor; 53 controller; 54 rear camera module; 55 rotating module; 56 base block; 57 slider; 58 translational power component; 59 belt wheel.

### DETAILED DESCRIPTION OF THE EMBODIMENTS

The present application will be further described in detail below in conjunction with the accompanying drawings.

### Embodiment I

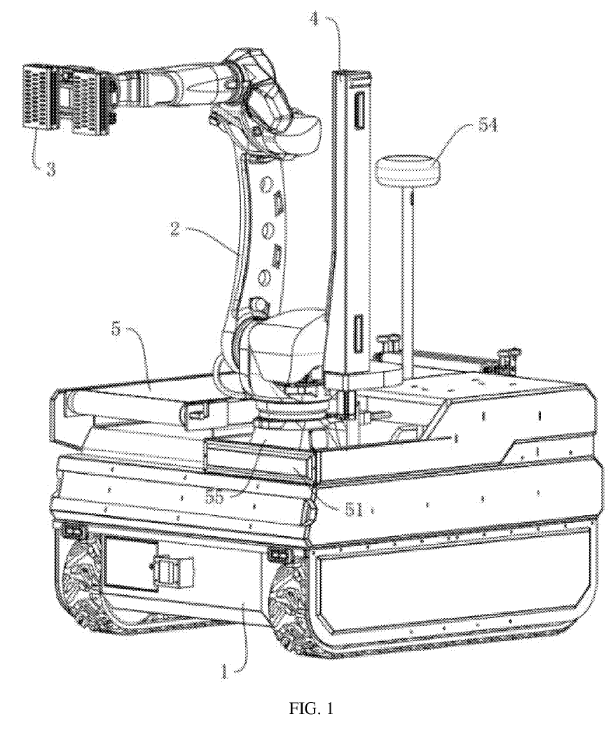

Embodiment I of the present application discloses an autonomous loading and unloading robot. Referring to FIG. 1, it includes a chassis 1 which may be of a crawler type and is capable of free movement. A horizontal conveying module 5 is detachably connected to an upper surface of the chassis 1. The conveying module 5 may be composed of a belt line and a telescopic roller line located at a tail portion of the chassis 1 to convey a cargo box to a designated position. A robotic arm 2 is provided directly above the chassis 1. A sucking disc 3 capable of attaching to a cargo box by suction is detachably connected to an end of the robotic arm 2, so that the cargo box can be placed at a front end of the conveying module 5. A front camera module 4 is detachably connected to one rotating shaft of the robotic arm 2. The front camera module 4 may be composed of a 3D camera, a fill light, and the like, so as to acquire the position and size parameters of a cargo box to be loaded and unloaded, and thus enable the sucking disc 3 to stably attach to the center of surfaces of cargo boxes at different positions and of different sizes by suction.

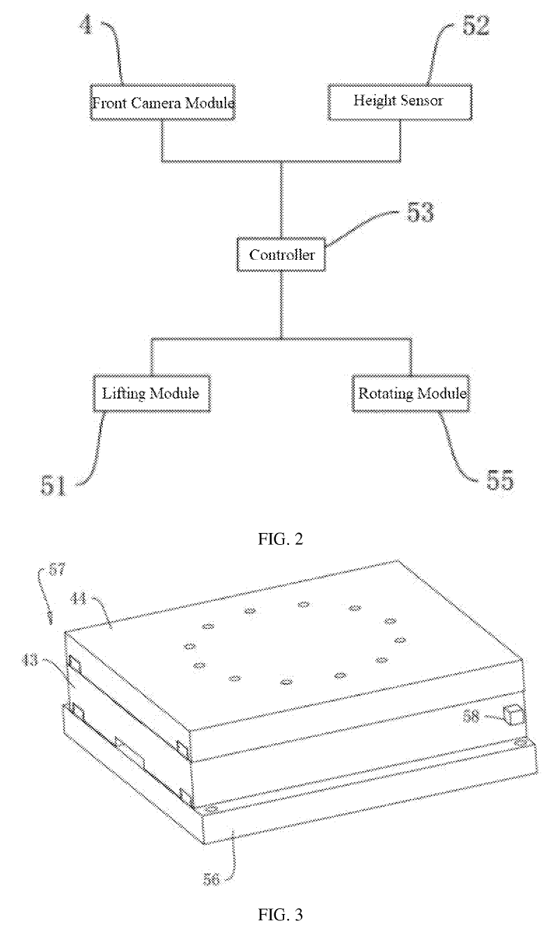

Referring to FIGS. 1 and 2, a lifting module 51 is detachably connected to a position at a front end of the chassis 1 close to the conveying module 5. The lifting module 51 may be composed of a servo ball screw module combined with a scissor lift mechanism. A rotating module 55 is detachably connected to the top of the lifting module 51 where height can be changed. The rotating module 55 may be a servo rotary electric cylinder. A rotating platform of the rotating module 55 is used for the detachable connection of a base of the robotic arm 2, and a height sensor 52 is detachably connected to the robotic arm 2. The height sensor 52, the rotating module 55, the lifting module 51, and the front camera module 4 are electrically connected to a controller 53, so that when the height of a carton is relatively high, the lifting module 51 lifts the robotic arm 2, and when the placement range of the cargo boxes to be loaded and unloaded is relatively wide, the rotating module 55 can drive the robotic arm 2 and the front camera module 4 to rotate synchronously, so as to ensure that the front camera module 4 can effectively cover the cargo boxes to be loaded and unloaded. In addition, the lifting module 51 is located at a side edge of the conveying module 5 along a conveying direction, so as to minimize the overall size of the chassis 1, and thus enable the chassis 1 to enter smaller spaces for loading and unloading cargo boxes.

Referring to FIG. 1, a rear camera module 54 is detachably connected to a position of the chassis 1 close to a rear end of the conveying module 5. The rear camera module 54 is configured the same as the front camera module 4. The rear camera module 54 can acquire the position and size of a cargo box entering a designated area at the rear end of the conveying module 5, so that an external clamping jaw can accurately grip and transfer the cargo box on the rear end of the conveying module 5. Meanwhile, a navigation radar module may also be integrated on a vertical pole where the rear camera module 54 is provided to identify a spatial positional relationship of objects around the chassis 1 and establish a map in real time to guide the movement and obstacle avoidance of the chassis 1.

Embodiment I of the present application further discloses a control method for the autonomous loading and unloading robot, which specifically includes the following steps:

Step 1: acquiring position and size parameters of a cargo box by the front camera module 4, and judging whether a height of the cargo box exceeds a preset height;

Step 2: when the height of the cargo box exceeds the preset height, calculating a difference between the height of the cargo box and the preset height to obtain a lifting height, and lifting the robotic arm 2 by the lifting module 51 with a lifting value being the lifting height;

Step 3: attaching to the center of the surface of the cargo box by suction by the sucking disc 3, and transferring the cargo box to a position directly above a front end of the conveying module 5 by the robotic arm 2;

Step 4: lowering the cargo box by the sucking disc 3, and conveying the cargo box to a rear end of the conveying module 5 by the conveying module 5;

Step 5: acquiring position and size parameters of the cargo box located at the rear end of the conveying module 5 by the rear camera module 54; and

Step 6: grasping and transferring the cargo box at the rear end of the conveying module 5 by an external clamping jaw.

The implementation principle of the autonomous loading and unloading robot and the control method therefor of Embodiment I of the present application is as follows: when the height of a cargo box is relatively high, after the lifting module 51 lifts the robotic arm 2 to a suitable height, the robotic arm 2 can attach to the center of a surface of the relatively high cargo box by suction, so that the cargo box can move stably.

### Embodiment II

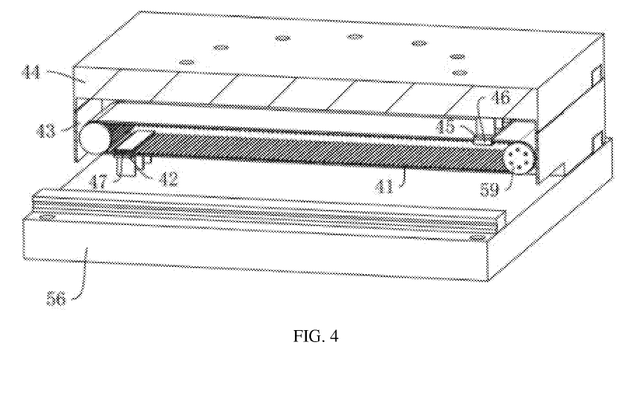

Embodiment II of the present application discloses an autonomous loading and unloading robot. Referring to FIGS. 3 and 4, the difference from Embodiment I is that a base block 56 is detachably connected to an upper portion of the lifting module 51 where height can be changed, and a slider 57 is slidably connected to an upper surface of the base block 56 along a width direction of the conveying module 5, that is, a moving direction of the slider 57 is perpendicular to a conveying direction of the conveying module 5. The slider 57 includes a middle block 43 slidably connected to the base block 56 and an upper block 44 slidably connected to the middle block 43. An upper surface of the upper block 44 is used for detachable connection of the rotating module 55. Two belt wheels 59 are rotatably connected inside the middle block 43, and a direction of a rotation axis of the belt wheels 59 is consistent with the conveying direction of the conveying module 5. A synchronous belt 41 is drivingly connected between the two belt wheels 59, and a moving direction of the synchronous belt 41 is consistent with the width direction of the conveying module 5.

Referring to FIGS. 3 and 4, a lower belt block 42 is detachably connected to a position of the upper surface of the base block 56 close to the conveying module 5, and the lower belt block 42 is fixedly connected to a lower surface of the synchronous belt 41. An upper belt block 45 is detachably connected to a lower surface of the upper block 44 that is at a side away from the conveying module 5, and the upper belt block 45 is fixedly connected to an upper surface of the synchronous belt 41. A translational power component 58 whose output shaft is coaxially detachably connected to the belt wheels 59 is detachably connected to a side surface of the middle block 43. The translational power component 58 may be a servo motor, so that when the cargo box is located at a side of the conveying module 5 away from the lifting module 51, the middle block 43 and the upper block 44 move synchronously, thereby moving the robotic arm 2 to a position directly above the conveying module 5 and improving the reachability of the robotic arm 2 in the width direction of the conveying module 5.

Referring to FIG. 4, the upper belt block 45 and the lower belt block 42 are each detachably connected with a concave fastening block 46, and the fastening block 46 is fixedly connected with a block rack 47 capable of meshing with the synchronous belt 41, so that the upper belt block 45 and the lower belt block 42 stably move synchronously along with the synchronous belt 41, thereby ensuring stable movement of the middle block 43 and the upper block 44.

The implementation principle of the autonomous loading and unloading robot of Embodiment II of the present application is as follows: through the movement of the middle block 43 and the upper block 44 along the width direction of the conveying module 5, the robotic arm 2 can be moved to a position directly above a front end of the conveying module 5, thereby improving the reachable range of the robotic arm 2 in a horizontal plane.

The above are all preferred embodiments of the present application, and are not intended to limit the protection scope of the present application. Therefore, all equivalent changes made according to the structure, shape, and principle of the present application shall be included in the protection scope of the present application.

What is claimed is:

1. A control method for an autonomous loading and unloading robot, for controlling operation of the autonomous loading and unloading robot, wherein the autonomous loading and unloading robot comprises: a movable chassis (1), a robotic arm (2) moving along with the chassis (1), a sucking disc (3) detachably connected to an end of the robotic arm (2) and configured to attach to a cargo box by suction, a front camera module (4) configured to acquire position and size parameters of a cargo box to be moved, and a conveying module (5) detachably connected to the chassis (1) and configured to receive the cargo box moved by the sucking disc (3) and convey the cargo box, wherein a lifting module (51) capable of adjusting a height of the robotic arm (2) is detachably connected to the chassis (1); a height sensor (52) is detachably connected to the robotic arm (2); and the height sensor (52), the front camera module (4), and the lifting module (51) are electrically connected to a controller (53);
wherein the lifting module (51) is located at a side edge of the conveying module (5) along a conveying direction;
wherein a base block (56) is detachably connected to a position of the lifting module (51) where height is changeable, a slider (57) capable of moving to a position directly above the conveying module (5) is slidably connected to the base block (56), the robotic arm (2) is capable of moving along with the slider (57), and a translational power component (58) for driving the slider (57) to move is detachably connected to the base block (56);
wherein two belt wheels (59) are rotatably connected inside the slider (57), a synchronous belt (41) is drivingly connected between the two belt wheels (59), a lower belt block (42) fixedly connected to the synchronous belt (41) is detachably connected to a side of the base block (56) close to the conveying module (5), and the belt wheels (59) are driven by the translational power component (58) to rotate;
wherein the slider (57) comprises a middle block (43) slidably connected to the base block (56) and an upper block (44) slidably connected to the middle block (43), the middle block (43) and the upper block (44) have a same sliding direction, and an upper belt block (45) fixedly connected to the synchronous belt (41) is detachably connected to a side of the upper block (44) away from the conveying module (5); and
wherein a rear camera module (54) is detachably connected to the chassis (1) near a rear end of the conveying module (5) and configured to confirm whether a cargo box exists at a designated position at the rear end of the conveying module (5), and the rear camera module (54) is electrically connected to the controller (53);
the control method specifically comprises the following steps:
Step 1: acquiring position and size parameters of a cargo box by the front camera module (4), and judging whether a height of the cargo box exceeds a preset height;
Step 2: when the height of the cargo box exceeds the preset height, calculating a difference between the height of the cargo box and the preset height to obtain a lifting height, and lifting the robotic arm (2) by the lifting module (51) with a lifting value being the lifting height;
Step 3: when a position of the cargo box is at a side of the conveying module (5) away from the robotic arm (2), operating the translational power component (58) to move the middle block (43) and the upper block (44) synchronously, so that the robotic arm (2) moves to the position directly above the conveying module (5);
Step 4: attaching to a center of a surface of the cargo box by suction by the sucking disc (3), and transferring the cargo box to a position directly above a front end of the conveying module (5) by the robotic arm (2);
Step 5: lowering the cargo box by the sucking disc (3), and conveying the cargo box to the rear end of the conveying module (5) by the conveying module (5);
Step 6: acquiring position and size parameters of the cargo box located at the rear end of the conveying module (5) by the rear camera module (54); and
Step 7: grasping and transferring the cargo box at the rear end of the conveying module (5) by an external clamping jaw.

2. The control method for the autonomous loading and unloading robot according to claim 1, wherein a rotating module (55) is detachably connected to the position of the lifting module (51) where the height is changeable; a position of the rotating module (55) where it is rotatable is used for detachable connection of the robotic arm (2); and the front camera module (4) is detachably connected to the robotic arm (2).

3. The control method for the autonomous loading and unloading robot according to claim 1, wherein the upper belt block (45) and the lower belt block (42) are each detachably connected with a fastening block (46) that is capable of being in close contact with the synchronous belt (41) and drivingly connected to surfaces of the belt wheels (59).

4. The control method for the autonomous loading and unloading robot according to claim 3, wherein the fastening block (46) is fixedly connected to a block rack (47) capable of meshing with the synchronous belt (41).
